(19) United States
(12) Patent Application Publication
(10) Pub. No.: US 2011/0113855 A1
(43) Pub. Date: May 19, 2011

(54) Analyte Gas Sensors

(76) Inventors: Michael Edward Badding, Campbell, NY (US); Aravind Raghavan Rammohan, Big Flats, NY (US); Jianhua Weng, Painted Post, NY (US)

(21) Appl. No.: 12/617,808

(22) Filed: Nov. 13, 2009

(51) Int. Cl. G01N 29/02

(52) U.S. Cl. 73/24.06; 73/31.07

(57) ABSTRACT

Apparatuses and methods for determining the concentration of an analyte gas in a gas stream with a sensor are described. The analyte gas sensor may include a mass-sensitive resonator and a diffusion barrier. The mass-sensitive resonator may be coated with an absorptive material which is reactive with an analyte gas, such as NOx. The diffusion barrier may be positioned to limit a gas flow with the analyte gas towards the absorptive material, and a ratio of the diffusion time of the gas flow through the diffusion barrier to the reaction time of the analyte gas with the absorptive material may be from about 0.1 to about 100.

### BACKGROUND

1. Field

The present specification generally relates to sensors for determining the concentration of an analyte gas in a gas stream and, more specifically, to sensors for determining the concentration of an analyte gas in a gas stream comprising a resonator and a diffusion barrier.

2. Technical Background

Various applications require analyte gas sensors capable of selectively measuring an analyte gas in a gas sample. Analyte gas sensors are of particular interest because of the negative environmental impact of certain analyte gases, such as, for example, NOx. The release of NOx compounds from the combustion of fossil fuels is a significant source of air pollution. The release of NOx into the atmosphere may adversely affect atmospheric ozone levels and lead to acid rain.

One source of NOx emissions is diesel engines including diesel engines used in automobiles, trucks, heavy equipment and ships. Because such diesel engines are extensively used throughout the world, and because such engines significantly contribute to the emission of NOx into the environment, the reduction of NOx emissions from these diesel engines has become a significant concern to both government agencies and automotive manufacturers. Due to the pervasive nature of diesel engines and increasing sensitivity to the harmful effects of NOx, practical NOx sensors for automotive and diesel emissions control systems are desired.

Accordingly, a need exists for alternative analyte gas sensors capable of selectively measuring an analyte gas in a gas sample.

### SUMMARY

According to one embodiment, an analyte gas sensor for determining a concentration of an analyte gas in a gas stream includes a mass-sensitive resonator and a diffusion barrier. The mass-sensitive resonator may be coated with an absorptive material which is reactive with the analyte gas. The diffusion barrier may be positioned to limit a gas flow comprising the analyte gas to the absorptive material, and a ratio of the diffusion time of the gas flow through the diffusion barrier to the reaction time of the analyte gas with the absorptive material is from about 0.1 to about 100.

In another embodiment, a method of sensing a concentration of an analyte gas in a gas stream includes positioning an analyte gas sensor in the gas stream. The analyte gas sensor includes a mass-sensitive resonator coated with an absorptive material and a diffusion barrier positioned to limit a gas flow comprising the analyte gas to the absorptive material. Additionally, the gas flow comprising the analyte gas may be pumped through the diffusion barrier towards the mass-sensitive resonator with the absorptive material. After the gas flow is pumped through the diffusion barrier, the gas flow may include a diffused concentration of analyte gas and the diffused concentration is about zero. Further, the analyte gas may be absorbed with the absorptive material. The concentration of the analyte gas may be determined based on a rate of mass change of the absorptive material.

Additional features and advantages of the invention will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 depicts a cross-sectional view of an analyte gas sensor for determining a concentration of an analyte gas in a gas stream according to one or more embodiments shown and described herein;

FIG. 2 graphically depicts the weight change of the absorptive material over time for five different values of the absorptive-diffusivity parameter;

FIG. 3. depicts a cross-sectional view of an analyte gas sensor for determining a concentration of an analyte gas in a gas stream according to one or more embodiments shown and described herein; and

FIG. 4 graphically depicts the relationship between the concentration of the analyte gas in the gas flow and the mass rate of change in the absorptive material for four different diffusion times.

### DETAILED DESCRIPTION

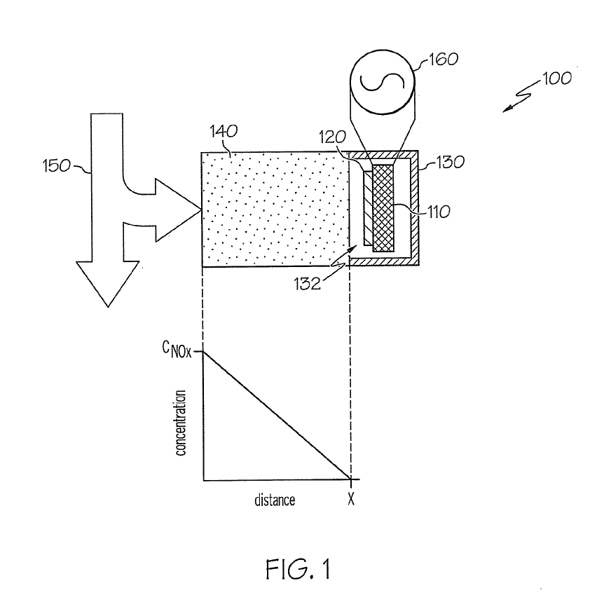

Reference will now be made in detail to various embodiments of analyte gas sensors, examples of which are illustrated in the accompanying drawings. Whenever possible the same reference numerals will be used throughout the drawings to refer to the same or like parts. One embodiment of an analyte gas sensor for determining a concentration of an analyte gas in a gas stream is shown in FIG. 1. The analyte gas sensor generally comprises a mass-sensitive resonator and a diffusion barrier. The mass-sensitive resonator may be coated with an absorptive material which is reactive with a specific analyte gas. The analyte gas sensor and methods for sensing a concentration of an analyte gas in a gas stream, such as the concentration of a NOx compound in a gas stream, will be described in more detail herein.

Referring to FIG. 1, one embodiment of an analyte gas sensor 100 for determining a concentration of an analyte gas in a gas stream 150 is depicted. The analyte gas sensor 100 generally comprises a mass-sensitive resonator 110, an absorptive material 120, and a diffusion barrier 140. In the embodiments described herein the mass-sensitive resonator 110 is a tuning fork resonator constructed from quartz or a similar material. The piezoelectric properties of the quartz cause the quartz to resonate at a specific frequency when a specific electric current is applied to the mass-sensitive resonator. While the mass-sensitive resonator 110 is described herein as comprising a tuning fork resonator, it should be understood that other types of mass-sensitive resonators may be used in the analyte gas sensor 100. For example, the mass-sensitive resonator 110 may comprise a bulk acoustic wave resonator, a microelectromechanical (MEMS) resonator or any other suitable mass-sensitive resonator.

In the embodiments of the analyte gas sensor 100 described herein the mass-sensitive resonator 110 is at least partially coated with an absorptive material 120. The absorptive material 120 is generally reactive with a specific analyte gas which the analyte gas sensor 100 is operable to detect. For example, in one embodiment described herein the analyte gas sensor 100 is operable to detect the concentration of a NOx compound in an exhaust gas stream, such as an exhaust gas stream generated by the combustion of hydrocarbon fuels. In this embodiment of the analyte gas sensor 100 the absorptive material 120 is reactive with NOx compounds. For example, the absorptive material 120 may comprise: alkali salts such as carbonates and hydroxides of sodium or potassium; alkaline earth salts such as calcium carbonates and hydroxides of calcium, strontium or barium; and oxides such as barium zirconium oxide (BaZrO₃), barium aluminate (BaAl₂O₄), and potassium titanium oxide K₂Ti₂O₅. In the embodiments described herein the absorptive material 120 is BaCO₃ which reacts with and absorbs NOx such that, as the absorptive material 120 reacts with the NOx, the mass of the absorptive material 120 increases.

While the absorptive material 120 has been described herein as being reactive with NOx compounds such that the analyte gas sensor 100 is operable to detect the concentration of NOx in a gas stream 150, it should be understood that the absorptive coating may be reactive with other analyte gasses such that the analyte gas sensor 100 is operable to detect those analyte gasses in a gas stream 150. For example, in an alternative embodiment, the absorptive material may comprise polymers which absorb ammonia gas such as, for example, poly(acrylic acid-co-isooctylacrylate). In this embodiment, the analyte gas sensor 100 may be operable to detect the concentration of ammonia in a gas stream 150.

Based on the foregoing, it should be understood that the specific analyte gas which the analyte gas sensor 100 is operable to detect is dependent upon the specific absorptive material 120 with which the mass-sensitive resonator 110 is coated. Accordingly, while the absorptive material 120 coating the mass-sensitive resonator 110 may be different for detecting different types of analyte gasses, it should be understood that the principles of operation of the analyte gas sensors described herein may be generally the same for different types of analyte gasses and absorptive materials.

Still referring to FIG. 1, the analyte gas sensors 100 described herein further comprise a diffusion barrier 140. The diffusion barrier 140 is generally operable to limit the flow of a gas stream 150 comprising the analyte gas to the absorptive material 120. Accordingly, it should be understood that the diffusion barrier 140 is disposed between the gas stream 150 and the absorptive material 120 such that the gas stream 150 diffuses through the diffusion barrier 140 before reacting with the absorptive material 120. In the embodiment illustrated in FIG. 1, the mass-sensitive resonator 110 may be disposed in a chamber 130 with the diffusion barrier 140 positioned over an inlet 132 to the chamber 130, as shown in FIG. 1. In this embodiment the diffusion barrier 140 may be spaced apart from the absorptive material 120 and the mass-sensitive resonator 110 as depicted in FIG. 1. Alternatively, the diffusion barrier 140 may be in direct contact with at least a portion of the absorptive material 120. The phrase “direct contact,” as used herein, means that the diffusion barrier 140 and the absorptive material 120 are in physical contact with one another.

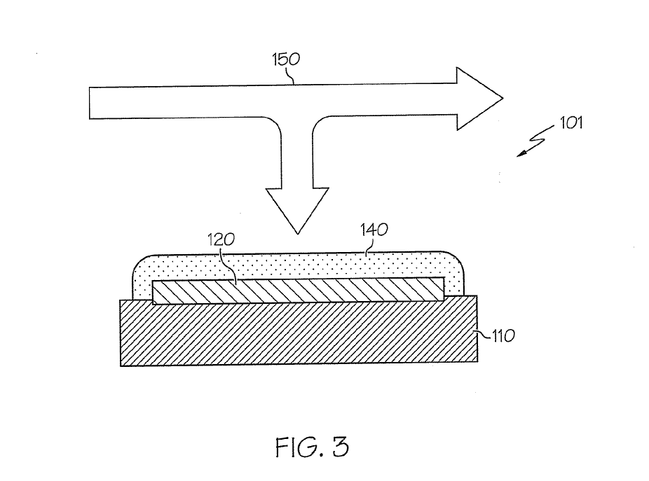

Referring now to FIG. 3, an alternative embodiment of an analyte gas sensor 101 is depicted. In this embodiment the analyte gas sensor 101 comprises a mass-sensitive resonator 110 coated with an absorptive material 120 which is reactive with a specific analyte gas, as described above. The absorptive material 120 covers at least a portion of the mass-sensitive resonator 110. In this embodiment, the mass-sensitive resonator 110 and the absorptive material 120 are not disposed in a chamber with the diffusion barrier 140 disposed over an inlet 132 of the chamber 130, as described above and illustrated in FIG. 1. Instead, in this embodiment, the diffusion barrier 140 is positioned in direct contact with the absorptive material 120 such that the absorptive material 120 is completely encapsulated between the diffusion barrier 140 and the mass-sensitive resonator 110. Accordingly, it should be understood that, in order for the gas stream 150 to reach the absorptive material 120, the gas stream 150 must diffuse through the diffusion barrier 140.

Referring now to FIGS. 1 and 3, the diffusion barrier 140 is generally a porous material which is non-reactive with the analyte gas or other gasses in the gas stream 150. For example, in one embodiment, the diffusion barrier 140 comprises a ceramic material with stable porosity at elevated temperatures including, without limitation, refractory materials such as alumina, zirconia, magnesia, silica and similar refractory materials. The desired sensitivity of the analyte gas sensor 100 may be achieved through use of a diffusion barrier 140 having a sufficiently low porosity with sufficient connectivity of the pore channels. This may be achieved by varying one or more of the porosity, thickness, and tortuosity of the diffusion barrier 140. By forming the diffusion barrier 140 from a material having a specific thickness, porosity and tortuosity the diffusion of the gas stream 150 through the diffusion barrier 140 may be controlled. In the embodiments of the analyte gas sensor 100 described herein the diffusion barrier 140 may have a porosity from about 0.05% to about 70%; a thickness from about 5 μm to about 1580 μm; and/or a tortuosity from about 2 to about 60.

Referring again to FIG. 1, the analyte gas sensor 100 may further comprise a frequency controller 160 that is electrically coupled to the mass-sensitive resonator 110 such that the resonance of the mass-sensitive resonator 110 can be monitored. For example, in one embodiment, the frequency controller 160 may be operable to apply an electrical signal, such as a current, to the mass-sensitive resonator 110 causing the resonator to resonate at a particular frequency. The frequency controller 160 may be further operable to monitor the change in the resonant frequency of the mass-sensitive resonator 110. Based on this change in frequency, a change in the mass of the mass-sensitive resonator 110/absorptive material 120 combination may be determined which, in turn, may be used to calculate the concentration of the analyte gas in the gas stream 150.

More specifically, in embodiments of the analyte gas sensor 100 where the analyte gas sensor is operable to detect NOx, the mass-sensitive resonator 110 includes a quartz tuning fork. Quartz, as a piezoelectric material, can be induced to resonate by electrical communication from the frequency controller 160. The quartz tuning fork will have a resonant frequency, f according to:

$$f = \frac{1}{2 π} \sqrt{\frac{k}{m}} , \qquad ( 1 )$$

where k is the effective spring constant and m is the effective mass of the quartz tuning fork. For example, a quartz tuning fork, generally, has a natural resonance frequency of about 32.7 kHz. As the mass of the absorptive material 120 positioned on the mass-sensitive resonator 110 changes as the absorptive material reacts with NOx, the resonant frequency of the mass-sensitive resonator 110 also changes with a change in the mass of the absorptive material 120. Considering, for example, a quartz tuning fork coated with barium carbonate, as the mass of the barium carbonate increases as it absorbs NOx, the mass of the quartz tuning fork will increase. Thus, by equation (1), the resonant frequency of the quartz tuning fork will decrease. This change in the resonant frequency of the mass-sensitive resonator may be detected with the frequency controller 160 and used to determine the change in mass of the absorptive material 120 and, in turn, the concentration of NOx in the gas stream 150.

Referring to FIGS. 1 and 3, when the analyte gas sensor 100, 101 is exposed to a gas stream 150, the diffusion barrier 140 provides an impediment to the diffusion of the analyte gas towards to mass-sensitive resonator 110 as the absorptive material 120 chemically pumps the analyte gas through the diffusion barrier 140. The degree to which the diffusion barrier 140 limits the flow of analyte gas to the absorptive material 120 is dependent on the thickness of the diffusion barrier 140, the tortuosity of the diffusion barrier 140, the porosity of the diffusion barrier 14 and the reaction rate between the absorptive material 120 and the analyte gas. The porosity, thickness and tortuosity of the diffusion barrier 140 should be such that, as the absorptive material 120 chemically pumps the analyte gas through the diffusion barrier, a concentration gradient of analyte gas is established across the diffusion barrier 140 as depicted in FIG. 1. More specifically, the porosity, thickness and tortuosity of the diffusion barrier 140 should be such that the analyte gas has a concentration of near zero at the side of the diffusion barrier proximate the absorptive material 120. When the concentration of analyte gas is near zero proximate the absorptive material 120 (i.e., when the concentration of the analyte gas is a diffused concentration of analyte gas proximate the absorptive material), all analyte gas pumped through the diffusion barrier 140 reacts with the absorptive material 120 thereby changing the mass of the absorptive material 120 which, in turn, changes the frequency at which the mass-sensitive resonator 110 resonates. The change in the frequency of the mass-sensitive resonator 110, as determined by the frequency controller 160, is used to determine the change in mass of the absorptive material 120 which, in turn, is used to determine the concentration of the analyte gas in the gas stream 150.

As described hereinabove, the use of the diffusion barrier 140 limits the flow of analyte gas to the absorptive material 120 and, as such, limits the rate at which the absorptive material 120 reacts with the analyte gas. Accordingly, the diffusion barrier 140 may be used to control or minimize changes in the absorption rate of the absorptive material 120 which may be caused by degradation of the microstructure of the absorptive material 120 over time due to large volume changes of the absorptive material as the analyte gas is absorbed by the absorptive material. More specifically, the absorption rate of the absorptive material 120 can be controlled by controlling the amount of time required for the analyte gas to diffuse through the diffusion barrier 140 and the time taken for the analyte gas to react to the absorptive material 120. The absorptive-diffusivity parameter A, which is the ratio between the time it takes for the analyte gas to diffuse through the diffusion barrier and the reaction time between the analyte gas and the absorptive material, can be expressed as:

$$A = \frac{{t}_{diffusion}}{{t}_{reaction}} , \qquad ( 2 )$$

where t_{diffusion} is the diffusion time of the analyte gas through the diffusion barrier 140 and t_{reaction} is the reaction time of the analyte gas with the absorptive material 120.

The absorptive-diffusivity parameter A was mathematically modeled for an analyte gas sensor operable to detect the concentration of NOx in a gas stream 150. More specifically, the mathematic model was based on an analyte gas sensor 100 which included a diffusion barrier 140 formed from a refractory material and a mass-sensitive resonator 110 formed from a quartz tuning fork coated with an absorptive material 120 comprising barium carbonate (BaCO₃). In the modeled example the diffusion time was given by the following equation:

$${t}_{diffusion} = \frac{{x}^{2}}{{D}_{NOx}} , \qquad ( 3 )$$

where x was the thickness of the diffusion barrier 140 and D_{NOx} was the diffusivity of the NOx compound through the diffusion barrier 140.

The reaction time of the absorptive material 120 comprising barium carbonate was calculated by:

$${t}_{reaction} = \frac{1}{k \times {C}_{Nox} \times θ {BaCO}_{3} \times {C}_{O 2}^{0.25}} , \qquad ( 4 )$$

where k is the rate constant, C_{NOx} is the NOx concentration in the gas stream 150, θBaCO₃ is the site concentration, and C_{O2} is the O₂ concentration.

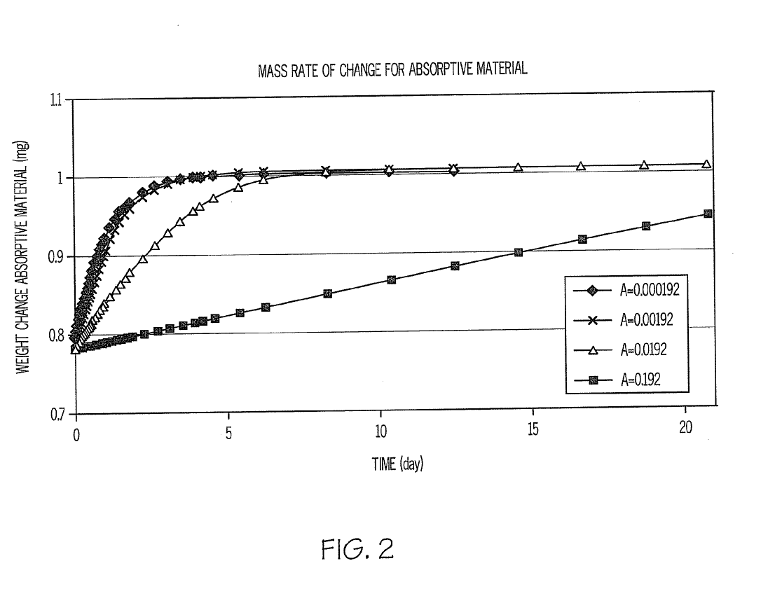

As shown in FIG. 2, when the absorptive-diffusivity parameter A is about 0.0192 or less, the mass weight change of the absorptive material rapidly approaches 1 mg which is the upper saturation threshold of the mass-sensitive resonator 110. Accordingly, when the absorptive-diffusivity parameter A is less than about 0.00192, the absorptive material 120 applied to the mass-sensitive resonator 110 rapidly absorbs the NOx compound which, in turn, rapidly increases the mass of the absorptive material 120. As the mass of the absorptive material 120 increases, the absorptive material 120 and/or the mass-sensitive resonator 110 becomes saturated and the analyte gas sensor is rendered unsuitable for further determining the concentration of the NOx compound in the gas stream 150. As shown in FIG. 1, this saturation generally occurs within a time scale of less than 10 days. When this condition occurs the absorptive material 120 must be regenerated to facilitate continued operation of the analyte gas sensor 100.

However, as the absorptive-diffusivity parameter A approaches a value of about 1, such as when the absorptive-diffusivity parameter A is greater than about 0.0192, the weight change of the absorptive material 120 is approximately linear over a time scale of about 20 to about 30 days. Under these conditions the saturation of the absorptive material 120 and/or mass-sensitive resonator 110 occurs over much longer time intervals and, as such, the analyte gas sensor 100 does not require regeneration as frequently.

As described above, the basic purpose of the diffusion barrier 140 is to limit the flow of analyte gas such that the change of mass at the absorptive material 120 occurs in an analytic manner. In the embodiments described herein the absorptive-diffusivity parameter is from about 0.1 to about 100, more preferably from about 0.5 to about 10, and most preferably about 1.

The diffusion barrier 140 establishes a relationship between the concentration of a NOx compound in the gas stream 150 and mass absorption rate over the life of the analyte gas sensor 100. When the analyte gas sensor 100 is in the pumping condition (e.g., when the concentration of NOx is approximately zero proximate the absorptive material 120), as described above, the mass rate of change in the absorptive material 120 is linearly related to the concentration of an NOx compound in the gas stream 150 according to Fick's law:

$$\frac{\partial m}{\partial t} = \frac{B \times FW \times {D}_{NOx} \times {C}_{NOx}}{x} , \qquad ( 5 )$$

where B is the cross-sectional area of the diffusion barrier 140, FW is the formula weight of the NOx compound, D_{NOx} is the diffusion coefficient of the NOx compound through the diffusion barrier 140 (dependent on porosity and tortuosity), C_{NOx} is the concentration of an NOx compound in the gas stream 150, and x is the thickness of the diffusion barrier 140. The importance of the mass rate of change in the absorptive material 120 will be described in more detail herein.

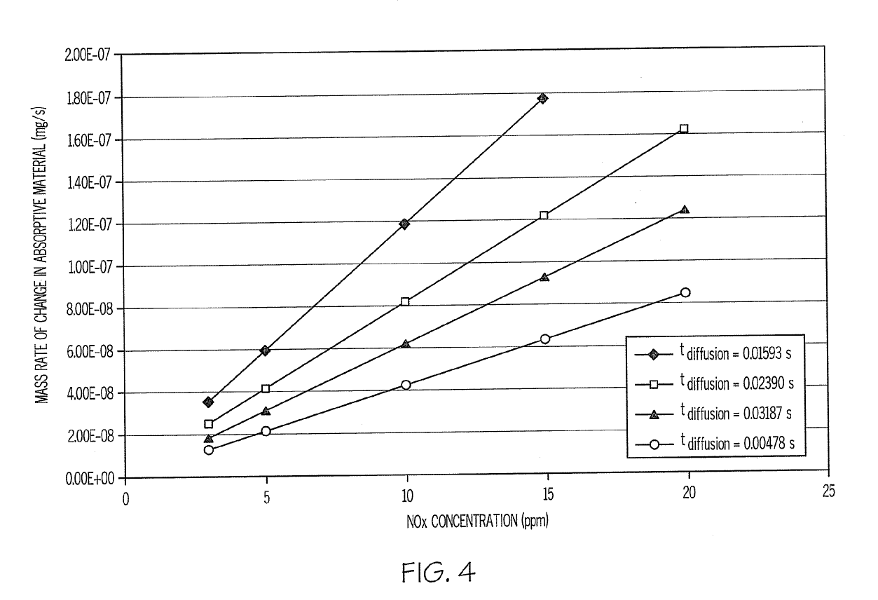

FIG. 4 graphically depicts the relationship between the concentration of the NOx compound in the gas stream 150 and the mass rate of change in the absorptive material 120. The detection sensitivity (for mass-sensitive resonators 110 utilized by embodiments of the present specification) is related to the slope of the curve depicting the relationship between the concentration of the NOx and the mass rate of change. Detection sensitivity is determined by the following equation:

$$S = \frac{\frac{\partial m 2}{\partial t} - \frac{\partial m 1}{\partial t}}{( {C}_{NOx 2} - {C}_{NOx 1} )} \times Δ Nox \times Δ t , \qquad ( 6 )$$

where

$$\frac{\partial m 1}{\partial t}$$

is the mass rate of change in the absorptive material 120 at a first point,

$$\frac{\partial m 2}{\partial t}$$

is the mass rate of change in the absorptive material 120 at a second point, C_{NOx1} is the concentration of an NOx compound in the gas stream 150 at a first point, C_{NOx2} is the concentration of an NOx compound in the gas stream 150 at a second point, ΔNOx is the change in the concentration of NOx in the gas stream 150 that the analyte gas sensor 100 is configured to detect, and Δt is the time period in which the concentration of NOx is to be detected by the analyte gas sensor 100. For example, referring still to FIG. 4, when the analyte gas sensor 100 is configured to detect a concentration of NOx that varies by 10 ppm/min in the gas stream 150 two points are chosen to determine the required detection sensitivity. Thus, for an analyte gas sensor 100 comprising a diffusion time (t_{diffusion}), as described hereinabove, of 0.0239 s,

$$\frac{\partial m 1}{\partial t}$$

is 8.0813 E-8 mg/s and C_{NOx1} is 10 ppm at a first point,

$$\frac{\partial m 2}{\partial t}$$

is 1.615 E-7 mg/s and C_{NOx2} is 20 ppm at a second point, ΔNOx is 10 ppm, and Δt is 1 min. By applying equation (6), it is shown that when the analyte gas sensor 100 is configured to detect a concentration of NOx that varies by a 10 ppm/min in the gas stream 150, the mass-sensitive resonator 110 is able to detect about a 4.8 nanogram weight change in the absorptive material 120. Similarly, when configured for a 1 ppm/min change in the gas stream 150, the mass-sensitive resonator 110 is able to detect a corresponding weight change of about 0.48 nanograms in the absorptive material 120. Furthermore, FIG. 4 shows that the relationship remains approximately linear when the diffusion time of the NOx compound through the diffusion barrier 140 is varied. Thus, embodiments of the analyte gas sensor 100 may comprise a diffusion barrier 140 with varied porosity, thickness, and tortuosity.

As described above, it has been determined that an analyte gas sensor 100 suitable for detecting NOx may be formed from a quartz tuning fork resonator coated with a barium carbonate absorptive material 120 and a diffusion barrier 140 formed from a refractory material. In one embodiment, the diffusion barrier 140 has a porosity of about 0.05%, a thickness of about 50 μm, and a tortuosity of about 3. In another embodiment, the diffusion barrier 140 has a porosity of about 50%, a thickness of about 1.6 mm, and a tortuosity of about 3. In a further embodiment, the diffusion barrier 140 has a porosity of about 50%, a thickness of about 0.353 mm, and a tortuosity of about 60. In yet another embodiment, the diffusion barrier 140 has a porosity of about 1%, a thickness of about 50 μm, and a tortuosity of about 60. However, it should be understood that other values for the porosity, tortuosity and thickness of the diffusion barrier may be used to form a NOx sensor with acceptable performance (i.e., to achieve an absorptive-diffusivity parameter A from about 0.1 to about 100).

As depicted in FIG. 4, the relationship between the concentration of the NOx compound in the gas stream 150 and the mass rate of change in the absorptive material 120 remains linear for different diffusion times and, as such, the diffusion barrier 140 enables flexibility with respect to the type of absorptive material 120 employed. This is due to the fact that the pumping condition is established for appropriate values of the absorptive-diffusivity parameter. Therefore, since the approximately linear relationship can be maintained with varied diffusion times of the analyte gas through the diffusion barrier, the reaction time of the absorptive material 120 may be correspondingly varied. Accordingly, while specific examples described herein relate to the detection of a NOx compound in a gas stream, the basic principles of operation of the analyte gas sensor may be extended to analyte gas sensors for detecting other analyte gasses in a gas stream.

As noted herein, the analyte gas sensor 100 may become saturated over time thereby requiring regeneration to facilitate continued operation of the sensor. To facilitate regeneration, the analyte gas sensor 100 may comprise a heating element (not shown) in thermodynamic communication with the absorptive material 120. The heating element may regenerate the absorptive material 120 through an increase in temperature such that a chemical reaction occurs and a waste compound is released from the absorptive material 120. Such a chemical reaction may significantly restore the structure of the absorptive material 120 to the state that existed prior to absorbing the analyte gas. The waste compound may then diffuse through the diffusion barrier 140 away from the mass-sensitive resonator 110 and the absorptive material 120. Such regeneration may occur at any time, such as, but not limited to, periodically, on command or when the absorptive material 120 is saturated.

It should now be understood that various embodiments of the analyte gas sensor 100 may be configured to sense NOx compounds in the exhaust gas stream of a diesel engine exhaust. The analyte gas sensor 100 may be electrically coupled to a diesel engine controller and placed, for example, in the exhaust pipe of a diesel engine exhaust. In such an embodiment, the exhaust stream may contain a concentration of NOx compounds and the analyte gas sensor 100 may comprise a quartz tuning fork coated with barium carbonate and a diffusion barrier of refractory material which limits the diffusion of the NOx compound from the exhaust stream to the barium carbonate. The NOx compound is chemically pumped through the refractory material and the concentration of the NOx compound proximate the barium carbonate coating is reduced to an amount that is about zero. The NOx compound is absorbed by the barium carbonate which, in turn, increases the mass of the barium carbonate. The increase in mass causes a decrease in the resonant frequency of the quartz tuning fork that is electrically coupled to the diesel engine controller. Thus the diesel engine controller is operable to sense the amount of NOx compound in the diesel engine exhaust stream based on the change in the resonant frequency of the quartz tuning fork. Furthermore, a sensor heater may be configured to heat the barium carbonate periodically to release the absorbed NOx compound. The NOx compound may then diffuse through the refractive material away from the quartz tuning fork and the barium carbonate, thereby regenerating the barium carbonate coating. It should now be understood that embodiments of the analyte gas sensor described herein may be used to detect the concentration of an analyte gas in a gas stream by monitoring the mass rate of change of the absorptive coating applied to the mass-sensitive resonator. Further, it should also be understood that the diffusion barrier of the analyte gas sensor is operable to limit the flow of analyte gas to the absorptive coating such that the mass rate of change of the absorptive coating occurs in an analytic manner over a desired time period. As such, saturation of the analyte gas sensor is avoided thus decreasing the frequency at which the analyte gas sensor must be regenerated and prolonging the life of the analyte gas sensor.

Specific examples of the analyte gas sensor described herein relate to an analyte gas sensor operable to detect the concentration of NOx in a gas stream, such as an exhaust gas stream produced by a diesel engine. In these embodiments the absorptive material comprises a barium carbonate coating which is reactive with NOx compounds. However, it should be understood that the absorptive coating may comprise other materials which are reactive with other analyte gasses. Accordingly, it should be understood that the analyte gas sensor may be configured to detect other analyte gasses by appropriate selection of the absorptive material without changing the basic principles of operation of the analyte gas sensor.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An analyte gas sensor for determining a concentration of an analyte gas in a gas stream comprising a mass-sensitive resonator and a diffusion barrier, wherein:
the mass-sensitive resonator is coated with an absorptive material which is reactive with the analyte gas; and
the diffusion barrier is positioned to limit a gas flow comprising the analyte gas to the absorptive material, wherein a ratio of a diffusion time of the gas flow through the diffusion barrier to a reaction time of the analyte gas with the absorptive material is from about 0.1 to about 100.

2. The analyte gas sensor of claim 1 wherein the mass-sensitive resonator is disposed in a chamber and the diffusion barrier is positioned over an inlet to the chamber.

3. The analyte gas sensor of claim 1 wherein the diffusion barrier at least partially covers the absorptive material and is in direct contact with at least a portion of the absorptive material.

4. The analyte gas sensor of claim 1 wherein the diffusion barrier has a porosity from about 0.05% to about 70%.

5. The analyte gas sensor of claim 1 wherein the diffusion barrier has a thickness from about 5 μm to about 1580 μm.

6. The analyte gas sensor of claim 1 wherein the diffusion barrier has a tortuosity from about 2 to about 60.

7. The analyte gas sensor of claim 1 wherein the diffusion barrier has a porosity of about 0.05%, a thickness of about 50 microns and a tortuosity of about 3.

8. The analyte gas sensor of claim 1 wherein the diffusion barrier has a porosity of about 50%, a thickness of about 1.6 millimeters and a tortuosity of about 3.

9. The analyte gas sensor of claim 1 wherein the diffusion barrier has a porosity of about 50%, a thickness of about 0.353 millimeters and a tortuosity of about 60.

10. The analyte gas sensor of claim 1 wherein the mass-sensitive resonator is selected from the list consisting of bulk acoustic wave sensors, tuning fork resonators, and microelectromechanical resonators.

11. The analyte gas sensor of claim 1 wherein the analyte gas is an NOx compound.

12. The analyte gas sensor of claim 11 wherein the absorptive material is reactive with the NOx compound.

13. The analyte gas sensor of claim 1 wherein the diffusion barrier comprises a refractory material.

14. The analyte gas sensor of claim 1 further comprising a heating element for heating the absorptive material.

15. A method of sensing a concentration of an analyte gas in a gas stream comprising:
positioning an analyte gas sensor in the gas stream, the analyte gas sensor comprising a mass-sensitive resonator coated with an absorptive material and a diffusion barrier positioned to limit a gas flow comprising the analyte gas to the absorptive material;
pumping the gas flow comprising the analyte gas through the diffusion barrier towards the mass-sensitive resonator with the absorptive material wherein, after the gas flow is pumped through the diffusion barrier, the gas flow comprises a diffused concentration of analyte gas and the diffused concentration is about zero;
absorbing the analyte gas with the absorptive material; and
determining the concentration of the analyte gas in the gas stream based on a rate of mass change of the absorptive material.

16. The method of claim 15 wherein a ratio of a diffusion time of the gas flow through the diffusion barrier to a reaction time of the analyte gas with the absorptive material is from about 0.1 to about 100.

17. The method of claim 15 further comprising regenerating the absorptive material.

18. The method of claim 17 wherein the absorptive material is regenerated when the absorptive material is saturated.

19. The method of claim 17 wherein the concentration is determined based on the change in resonance of the mass-sensitive resonator.

20. The method of claim 15 wherein the analyte gas is a NOx compound.
